(19) United States
(12) Patent Application Publication
(10) Pub. No.: US 2024/0141531 A1
(43) Pub. Date: May 2, 2024

(54) Galvanic Growth of Nanowires on a Substrate

(71) Applicant: NanoWired GmbH, Gernsheim (DE)

(72) Inventors: Olav Birlem, Gernsheim (DE); Florian Dassinger, Gernsheim (DE); Sebastian Quednau, Gernsheim (DE); Farough Roustaie, Gernsheim (DE)

(21) Appl. No.: 18/279,234

(22) PCT Filed: Feb. 22, 2022
(86) PCT No.: PCT/EP2022/054380

§ 371 Date: Aug. 29, 2023

(30) Foreign Application Priority Data
Mar. 3, 2021 (DE) 10 2021 105 126.6

(51) Int. Cl. C25D 1/00; C25D 1/04; B82Y 30/00; B82Y 40/00

(52) U.S. Cl. CPC C25D 1/006; C25D 1/04; B82Y 30/00; B82Y 40/00

(57) ABSTRACT

Apparatus for galvanically growing a plurality of nanowires on a substrate, comprising a substrate holder and a receptacle for the substrate holder, the apparatus being designed to grow the plurality of nanowires on the substrate when the substrate holder with the substrate has been received in the receptacle, the substrate holder having electronics which are designed to influence the growing of the nanowires.

The invention relates to an apparatus and a method for galvanically growing a plurality of nanowires on a substrate.

Apparatuses and methods with which nanowires can be produced are known. For example, nanowires can be obtained by galvanic processes or by means of methods that are known from thin-film technology. It is common to many known methods that they require complex machines, and in particular for this reason are usually only used (can only be used) in laboratories and in clean rooms. In particular, most known methods are not suitable for industrial use.

Also, many known apparatuses and methods have the disadvantage that the nanowires obtained vary greatly in their properties, and in particular with respect to their quality. The nanowires from different growing processes often differ, sometimes considerably, even if the same machines, starting materials and/or formulations are used. The quality of nanowires often depends in particular on the ability of the user of a corresponding apparatus or the user of a corresponding method, on environmental influences and/or also simply on chance. All of this is made more difficult by the fact that nanowires are structures which sometimes cannot even be seen with an optical microscope. Therefore, elaborate investigations may be necessary to make it possible in the first place to ascertain the described properties (and in particular the fluctuations in them).

On this basis, the object of the invention is to provide an apparatus and a method with which a plurality of nanowires can be produced with particularly consistent quality.

This object is achieved by the apparatus and the method according to the independent claims. Further advantageous configurations are indicated in the dependent claims. The features represented in the claims and in the description can be combined with one another in any technologically meaningful way.

According to the invention, an apparatus for galvanically growing a plurality of nanowires on a substrate is provided. The apparatus comprises a substrate holder and a receptacle for the substrate holder, the apparatus being designed to grow the plurality of nanowires on the substrate when the substrate holder with the substrate has been received in the receptacle, the substrate holder having electronics which are designed to influence the growing of the nanowires.

With the apparatus described, nanowires can be produced. A nanowire is understood here as meaning any body of material that has a wire-like form and a size in the range of a few nanometres to a few micrometres. A nanowire may for example have a circular, oval or polygonal base area. In particular, a nanowire may have a hexagonal base area.

The nanowires preferably have a length in the range from 100 nm (nanometres) to 100 μm (micrometres), in particular in the range from 500 nm to 60 μm. The nanowires also preferably have a diameter in the range from 10 nm to 10 μm, in particular in the range from 30 nm to 2 μm. Here, the term diameter relates to a circular base area, a comparable definition of a diameter being applicable if a base area deviates from this. It is particularly preferred that all of the nanowires used have the same length and the same diameter.

The described apparatus can be used for a wide variety of materials of the nanowires. Electrically conducting materials, in particular metals such as copper, silver, gold, nickel, tin and platinum, are preferred as the material of the nanowires. However, non-conducting materials, such as metal oxides, are also preferred. Preferably, all of the nanowires are formed from the same material.

The nanowires may be grown onto the surface of the substrate with the apparatus. The surface of the substrate is preferably made to be electrically conducting. If the surface is part of a substrate that is otherwise not electrically conducting, the electrical conductivity can be achieved for example by a metallization. Thus, for example, a substrate that is not electrically conducting may be coated with a thin layer of metal. The metallization can be used in particular to produce an electrode layer. Depending on the material of the surface of the substrate and/or the electrode layer, it may be advisable to provide a bonding layer between the surface of the substrate and the electrode layer that imparts an adhesive bond between the surface and the electrode layer.

The electrical conductivity of the surface of the substrate allows it to be used as an electrode for the galvanic growing of the nanowires. The substrate may be in particular a silicon substrate. The substrate may be in particular a body which is provided with electrically conducting structures. It may be in particular a silicon chip or a so-called printed circuit board (PCB).

With the apparatus described, the nanowires can be galvanically grown onto the surface of the substrate in pores of a foil. An electrolyte is used for this. The nanowires can be provided in a particularly consistent quality if, during the growing, the foil lies closely against the surface of the substrate and the electrolyte is evenly distributed over the foil. This can be achieved by an elastic element permeable to the electrolyte such as a sponge lying on the foil. An electrolyte can be released onto the foil through the elastic element and the foil can be held on the surface of the substrate.

The foil is preferably placed onto the surface to be grown on of the substrate before the beginning of the growing of the nanowires. The foil is preferably formed by a plastics material, in particular by a polymer material. In particular, it is preferred that the foil is connected to the surface in such a way that the foil does not slip. This could reduce the quality of the nanowires grown.

The foil has a plurality of passing-through pores, in which the nanowires can be grown. The pores are preferably made to pass through the foil by being formed by channels which pass through from an upper side of the foil to an underside of the foil. In particular, it is preferred that the pores are made to be cylindrical. However, it is also possible that the pores are made as channels following a curved path. A pore may have for example a circular, oval or polygonal base area. In particular, a pore may have a hexagonal base area. The pores are preferably formed uniformly (i.e. the pores preferably do not differ with respect to the size, shape, arrangement and/or distance from adjacent pores). When the nanowires are being grown, the pores are preferably filled (in particular completely) with the galvanically deposited material. This makes the nanowires take on the size, shape and arrangement of the pores. The properties of the nanowires to be grown can therefore be established or influenced by the choice of the foil or the pores therein. The foil may therefore also be referred to as a “template”, “template foil” or “pattern”.

The apparatus comprises a substrate holder and a receptacle for the substrate holder. The substrate can be held by the substrate holder and can be received with the substrate holder in the receptacle. Once the substrate holder with the substrate has been received in the receptacle, the nanowires can be grown on the substrate. For this, the substrate holder is preferably formed in such a way that the electrolyte can be brought into contact with the surface to be grown on of the substrate. For this, the substrate holder may for example have a depression into which the substrate can be placed. The electrolyte can be introduced into the depression, so that the surface to be grown on of the substrate is completely covered by the electrolyte.

The apparatus preferably has a housing, in which the receptacle is formed. To this extent, the apparatus can be considered to be a compact machine. The housing preferably comprises a chamber, in which the receptacle is arranged. The substrate holder may in this case be introduced into the chamber by the substrate holder being inserted into the receptacle. The chamber is preferably closable. For example, the chamber may be accessible by way of an opening in a housing wall, so that the substrate holder can be inserted into the chamber and into the receptacle through the opening. The opening may for example be closable by a flap. In the closed state, the chamber is preferably liquid- and gas-tight. Thus, an atmosphere desired for the growing of the nanowires can be created inside the chamber. Moreover, chemicals can be prevented from escaping from the chamber. The chamber may preferably be locked. Thus, the opening may for example be closed by a flap and the flap may be held in its position by a locking mechanism. Consequently, inadvertent opening of the chamber during a growing process can be prevented. The chamber is preferably formed within a bounding enclosure of a material that is resistant to the chemicals used when growing the nanowires, for example steel or plastic.

The chamber preferably has a respective feed for at least one chemical. For example, the electrolyte used for growing the nanowires may be provided in this way. The electrolyte may for example be introduced by way of the corresponding feed into a depression of the substrate holder, so that the electrolyte comes into contact with the substrate arranged in the depression. Furthermore, a feed for water may be provided, in particular for deionized water (DI water). This may be used for rinsing the substrate after completion of the growing of the nanowires. It can in this way be prevented that residual amounts of the electrolyte leave the apparatus with the substrate. Furthermore, the chamber preferably has at least one outlet. Thus, for example, an outlet by way of which the electrolyte can be let out of the chamber after completion of the growing of the nanowires may be provided. An outlet for the water used for rinsing may also be provided. The electrolyte and the water may be let out of the chamber by way of the same outlet or by way of different outlets.

Furthermore, the chamber preferably has a ventilating opening. This allows gases in the chamber to be let out of the chamber. Thus, a user can be protected from harmful gases escaping from the chamber when it is opened. The gases can be extracted from the chamber by way of the ventilating opening and replaced for example by fresh air or an inert atmosphere. The extracted gases may for example be cleaned. Furthermore, an electrode designed for the growing of the nanowires is preferably arranged in the chamber. Thus, an electrical voltage may be applied between the electrode and the surface to be grown on of the substrate in order to grow the nanowires. The electrode is preferably held on a ram. The ram is preferably automatically movable. Thus, the ram can be used to bring the electrode into contact with the electrolyte in order to grow the nanowires. This may involve an elastic element such as a sponge that is placed on the foil being pressed onto the foil by the ram. The foil can in this way be held in its position. The ram may also have an electrolyte distributor. Thus, the electrolyte can be fed by the ram to the surface to be grown on of the substrate. The electrolyte distributor may have a plurality of outlets on an outlet side, so that the electrolyte can be fed by way of the electrolyte distributor uniformly to the surface to be grown on of the substrate. The electrode may be formed on the outlet side of the electrolyte distributor. Thus, the outlets may adjoin corresponding through-openings in the electrode, so that the electrolyte can pass through the electrode by way of the through-openings.

The substrate holder is preferably formed as a drawer. This means that the substrate holder can be pushed into the receptacle, for example over guide rails arranged laterally in the receptacle. It is preferred that the drawer can be separated completely from the rest of the apparatus. Alternatively, the amount by which the drawer can be pulled out may be limited to a maximum extent, so that the drawer cannot be pulled out beyond the maximum extent.

The apparatus preferably has a drive for moving the substrate holder. For example, the substrate holder may be brought manually into a loading position and from there be drawn into the receptacle in an automated manner by the drive. After completion of the growing of the nanowires, the substrate holder may be moved out of the receptacle in an automated manner, in particular into a removal position, which is preferably identical to the loading position. From the removal position, the substrate holder can be removed manually. Alternatively, the apparatus may be designed to move the substrate holder into the receptacle and out of the receptacle completely manually. It is also conceivable that an apparatus with a drive for the substrate holder is operated according to choice with an automatically moved substrate holder or a manually moved substrate holder.

The apparatus preferably has an arresting mechanism for arresting the substrate holder in the receptacle. The arresting mechanism is preferably formed such that the arresting mechanism has an active state and a deactivated state. The arresting mechanism can therefore be switched on and off. An electromagnet which in the switched-on state holds the substrate holder in the receptacle may be provided for example for this. Thus, with the arresting mechanism, the substrate holder can be secured in the receptacle during the growing of the nanowires. After completion of the growing of the nanowires, the arresting mechanism can be deactivated and the substrate holder can be removed from the receptacle.

The apparatus is preferably formed in conformity with clean-room requirements. If the apparatus is used in a clean room, the nanowires grown with the apparatus can also be protected after removal of the substrate holder from the receptacle.

The substrate holder has electronics which are designed to influence the growing of the nanowires. For this, the following parameters for example may be monitored by the electronics: the temperature of the surface to be grown on of the substrate, the distribution of this temperature, the filling level of the electrolyte, the current intensity of the electrical current used for the growing of the nanowires. Furthermore, the electronics may be designed to identify the electrolyte. Thus, for example, a response can be triggered if an electrolyte other than the intended one is detected. The composition of the electrolyte can also be determined by the electronics. The electronics may also be designed to contribute to the monitoring and/or controlling of process sequences.

The apparatus is preferably designed such that the growing of the nanowires only begins when it has been detected by the electronics that one or more specified preconditions have been satisfied. Thus, for example, the electronics may have an identification that can be used to check whether the correct substrate holder has been inserted into the receptacle. At what time maintenance work is required may also be stored in the electronics. One of the specified preconditions may in this case be that no maintenance work is due at the time.

The substrate holder preferably has a heater. This can be used to influence a temperature prevailing during the growing of the nanowires. Thus, the heater may be designed to heat the electrolyte and/or the surface to be grown on of the substrate. The heater is preferably an electrical heater. The heater may be controlled by the electronics of the substrate holder and/or externally.

In a preferred embodiment of the apparatus, the substrate holder has an interface by way of which the electronics are connected to a control unit of the apparatus when the substrate holder has been received in the receptacle.

The interface may for example comprise one or more plug-in connections. The plug-in connections are preferably formed in such a way that the electronics of the substrate holder are connected to the control unit when the substrate holder has been inserted into the receptacle. A separate manipulation by an operator, for example the connecting of cables, is in this case not required.

The control unit is preferably designed to process signals output by the electronics of the substrate holder and/or to output control signals to the electronics of the substrate holder. The control unit preferably has a database. In this case, parameters which have been transmitted from the electronics of the substrate holder to the control unit can be compared with corresponding expected values. In the case of discrepancies, for example a warning signal may be emitted, the process may be interrupted and/or a correction may be performed in an automated manner by way of a corresponding control signal. By way of a corresponding control signal, the heating of the substrate holder may be controlled by the control unit.

The control unit is preferably arranged in the housing. Furthermore, the apparatus preferably has a display means and/or an operating means, which are in particular connected to the control unit. The display means and/or the operating means are preferably held in or on the housing in such a way that they are accessible for a user. The display means allows information on the growing process to be indicated to the user, the operating means allows the user to control the process. The display means and the operating means may also be formed as a display and operating means, for example as a touchscreen.

If the apparatus has an arresting mechanism for arresting the substrate holder in the receptacle, the control unit is preferably designed to monitor and/or control the arresting mechanism. If the apparatus has a drive for moving the substrate holder, the control unit is preferably designed to monitor and/or control the drive. If the apparatus has a chamber which is closable by a flap that can be locked by a locking mechanism, the control unit is preferably designed to monitor and/or control the locking mechanism. For example, the control unit may detect that the substrate holder has been placed into the loading position and, in response to this, initiate by way of corresponding control signals that the substrate holder is drawn into the receptacle in an automated manner and arrested there by the arresting mechanism and that the opening of the chamber is closed by the flap and the flap is locked. During the growing of the nanowires, the control unit may monitor that the arresting mechanism and the locking mechanism remain unchanged. After completion of the growing of the nanowires, the control unit may initiate by corresponding control signals that the locking mechanism of the flap is released and the flap is opened and that the arresting mechanism is released and the substrate holder is moved into the removal position in an automated manner.

In a further preferred embodiment of the apparatus, the electronics of the substrate holder comprise a digitizing unit, which is connected to the control unit for digital communication.

In this embodiment, the signals emitted by the electronics to the control unit are digital signals. As a result, particularly low-interference communication between the electronics and the control unit can be achieved.

In a further preferred embodiment of the apparatus, the electronics of the substrate holder comprise a sensory.

The sensory is preferably designed to record at least one growth parameter. Coming into consideration in particular as growth parameters are a temperature of the surface to be grown on of the substrate, a distribution of this temperature, a filling level of the electrolyte, a current intensity of the electrical current used for the growing of the nanowires. The sensory preferably comprises a respective sensor for the parameters to be measured. The sensory may also comprise a sensor which is designed to identify the electrolyte. The sensory may also comprise a sensor which is designed to determine a composition of the electrolyte.

In a further preferred embodiment, the apparatus also comprises a reference electrode, which is connected to the substrate when the substrate holder with the substrate has been received in the receptacle.

With the reference electrode, the growing of the nanowires can be monitored. For this, the voltage between the electrode and the reference electrode can be measured with the reference electrode. The arrangement may comprise one or more reference electrodes.

The electrode is preferably connected to the voltage source by way of a first cable. The surface to be grown on of the substrate is preferably connected to the voltage source by way of a second cable. The reference electrode is preferably connected to a voltmeter by way of a third cable. The surface of the substrate is preferably connected to the voltmeter by a fourth cable. The second cable and the fourth cable are preferably connected in each case directly to the surface. For this, the surface of the substrate may have a respective contact pad, by way of which the second cable and the fourth cable are connected to the surface of the substrate, for example by means of a respective conducting tape. The reference electrode is therefore not simply connected to the surface of the substrate by the reference electrode being connected by a branching of the second cable. It has been found that, by comparison, a direct attachment of the reference electrode to the surface of the substrate produces more accurate results.

The first cable, the second cable, the third cable and the fourth cable may in each case be divided into a number of portions, which are connected to one another for example by way of plug-in connections. The second cable, the third cable and/or the fourth cable may in each case be divided into portions in such a way that a respective transition between two adjacent portions of the corresponding cable is arranged at an edge of the drawer. The drawer may have a corresponding connector for each of these three cables. Thus, electrical contact between the surface of the substrate and the reference electrode may be made when the drawer is pushed into the receptacle by the three plug-in connections being formed. The voltmeter and the voltage source are preferably arranged inside the housing and outside the receptacle for the drawer.

In a further preferred embodiment of the apparatus, an electrode of the apparatus designed for the galvanic growing of the nanowires has a multiplicity of independently controllable segments and/or the substrate holder has a heater with a multiplicity of independently controllable segments. The “and” case is preferred.

For the galvanic growing of the nanowires, an electrical voltage is applied between the surface to be grown on of the substrate and the electrode. If the electrode has a multiplicity of independently controllable segments, the apparatus is particularly well-suited for growing nanowires on substrates of different sizes. Thus, various of the segments of the electrode may be used, depending on the size and shape of the substrate. The electrical voltage can thus be applied to the electrode in locally restricted fashion where the substrate lies opposite the electrode. It is also conceivable that different electrical voltages are applied with the various segments of the electrode. Thus, the growing of the nanowires can be controlled locally selectively. The electrode is divided into the segments in such a way that each of the segments lies opposite a respective part of the surface to be grown on of the substrate when the substrate holder with the substrate has been received in the receptacle.

If the substrate holder has a heater with a multiplicity of independently controllable segments, a temperature of the substrate can be controlled locally selectively. If the substrate is smaller than a maximum size of substrate that can be received by the substrate holder, energy can be saved by the heater only being active where the substrate is present. The heater is divided into the segments in such a way that each of the segments lies opposite a respective part of the substrate when the substrate holder with the substrate has been received in the receptacle.

The controlling of the segments of the electrode and/or heater is preferably performed by the control unit. For example, the size and shape of the loaded substrate can be detected by the sensory of the substrate holder and transmitted by way of a corresponding signal to the control unit, which then controls the electrode and/or the heater by way of corresponding control signals.

In a further preferred embodiment of the apparatus, the electronics of the substrate holder are designed to control an electrical voltage or an electrical current for the growing of the nanowires.

In this embodiment, the control unit can specify a voltage to be set or a current to be set and transmit them to the electronics of the substrate holder for example by way of a corresponding control signal. For this, the electronics of the substrate holder are designed to set the desired voltage or the desired current. For this, the electronics can measure the voltage or the current and control it to the desired setpoint value. This configuration is more flexible than control performed by using the control unit. This allows the apparatus to be used particularly easily with different substrate holders, which each have their own control characteristics. The control unit does not have to know the control characteristics. Instead, they can be individually taken into account in each substrate holder.

As a further aspect of the invention, a method for galvanically growing a plurality of nanowires on a substrate is provided. The method comprises:
a) placing the substrate into a substrate holder,
b) inserting the substrate holder into a receptacle for the substrate holder,
c) galvanically growing the nanowires on the substrate, the substrate holder having electronics which influence the growing of the nanowires.

The described advantages and features of the apparatus can be applied and transferred to the method, and vice versa. The apparatus is preferably designed for being operated according to the method. The method is preferably carried out with the apparatus.

Steps a) to c) are preferably carried out in the sequence given.

In step a), the substrate is placed into the substrate holder. A foil is preferably placed onto the substrate when the substrate is placed into the substrate holder. Alternatively, the foil may also be placed onto the substrate after the substrate has been placed into the substrate holder. It is also preferred that an elastic element that is permeable to the electrolyte is placed on the foil when the substrate is placed into the substrate holder. Alternatively, the elastic element may also be placed onto the substrate after the substrate has been placed into the substrate holder. Preferably, in step a), the electronics of the substrate holder are used to record details of the substrate, for example the size, the shape and the material of the surface to be grown on of the substrate.

In step b), the substrate holder with the substrate is inserted into the receptacle for the substrate holder. This can be performed by the substrate holder being manually brought into a loading position and from there drawn into the receptacle in an automated manner, in particular by means of a drive for moving the substrate holder.

In step c), the nanowires are galvanically grown. For this, an electrolyte can be brought into contact with the surface to be grown on of the substrate and an electrode and an electrical voltage can be applied between the surface of the substrate and the electrode. The process is preferably controlled by way of the control unit. The nanowires can be grown into the pores of a foil placed onto the substrate.

The method preferably also comprises
d) removing the substrate holder from the receptacle.

Step d) is preferably carried out after completion of the growing of the nanowires according to step c). For this, the substrate holder may for example be moved in an automated manner into a removal position, in particular by means of a drive for moving the substrate holder. From the removal position, the substrate holder can be removed manually. Subsequently, the substrate can be removed from the substrate holder. The substrate holder can subsequently be used for a new growing process.

In a preferred embodiment of the method, before step a), growth parameters that are taken into account in step c) are stored in the electronics of the substrate holder.

In this embodiment, the substrate holder may be prepared to such an extent that the growing of the nanowires proceeds in a fully automated manner as soon as the substrate holder has been manually placed into the loading position. Thus, the control unit can detect that a substrate holder has been placed into the loading position and initiate that the substrate holder is drawn into the receptacle in an automated manner. As soon as the connection between the electronics of the substrate holder and the control unit has been formed, the control unit can for example read out from the electronics of the substrate holder which growth parameters are provided for the growing of the nanowires. The growing of the nanowires can be carried out with these parameters. Subsequently, the substrate holder may be moved in an automated manner into the removal position and removed there. In this case, an operator does not have to make any settings on the apparatus. It is sufficient that, when preparing the substrate holder, the operator stores the growth parameters in the electronics of the substrate holder. For this, the substrate holder may have an input device or be connected to an input device.

The following come into consideration in particular as growth parameters: a growing time, an electrical voltage or an electrical current, a temperature to be set for the substrate.

In a further preferred embodiment of the method, a temperature of the substrate in step c) lies between 15° C. and 100° C., preferably between 30° C. and 90° C. The details relate in particular to the temperature of the surface to be grown on of the substrate.

The invention is explained in more detail below on the basis of the figures. The figures show a particularly preferred exemplary embodiment, to which however the invention is not restricted. The figures and the relative sizes shown therein are only schematic. In the figures:

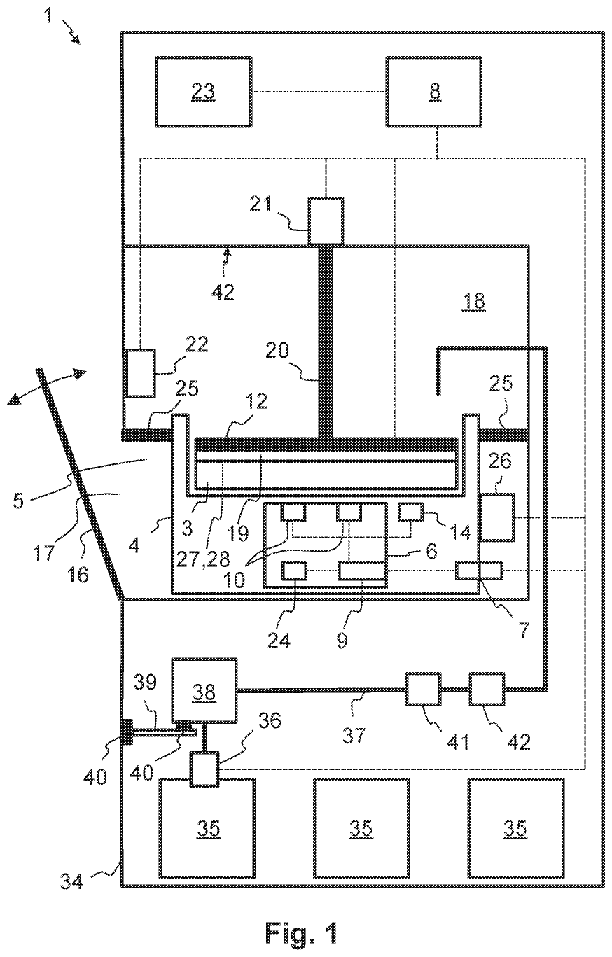

FIG. 1: shows an apparatus according to the invention for galvanically growing a plurality of nanowires on a substrate,

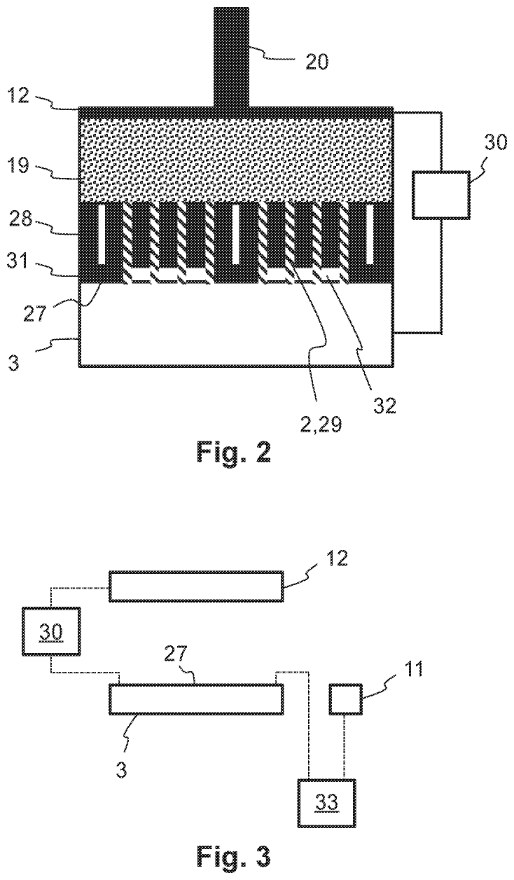

FIG. 2: shows a schematic representation of part of the apparatus from FIG. 1,

FIG. 3: shows a connection of a reference electrode for the apparatus from FIGS. 1 and 2,

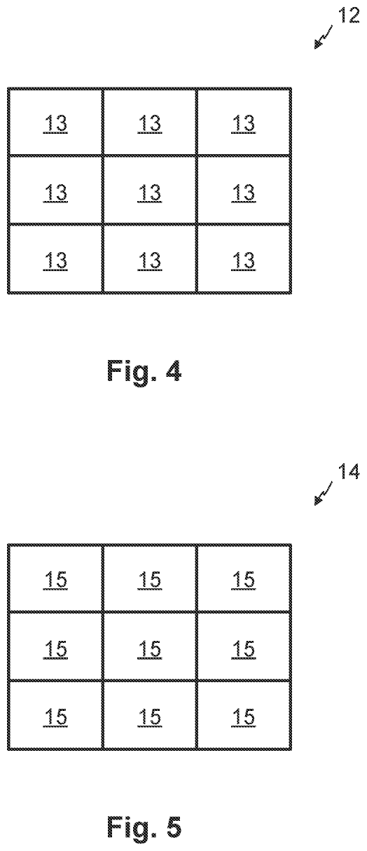

FIG. 4: shows a configuration of an electrode for the apparatus from FIGS. 1 and 2,

FIG. 5: shows a configuration of a heater for the apparatus from FIGS. 1 and 2.

FIG. 1 shows an apparatus 1 for galvanically growing a plurality of nanowires 2 (shown in FIG. 2) onto a surface 27 of a substrate 3. The apparatus 1 comprises a substrate holder 4, formed as a drawer, and a receptacle 5 for the substrate holder 4, formed in a chamber 18. The receptacle 5 has guide rails 25, over which the substrate holder 4 can be pushed into the receptacle 5 and can be pulled out from the receptacle 5. With an arresting mechanism 26, the substrate holder 4 can be arrested in the receptacle 5.

In the situation shown in FIG. 1, the substrate holder 4 has been received by the receptacle 5. The apparatus 1 is designed to grow the plurality of nanowires 2 on the substrate 3 when the substrate holder 4 with the substrate 3 has been received in the receptacle 5, as shown. The substrate holder 4 has electronics 6, which are designed to influence the growing of the nanowires 2. The substrate holder 4 has an interface 7, which is formed as a plug-in connection and by way of which the electronics 6 are connected to a control unit 8 of the apparatus 1 when the substrate holder 4 has been received in the receptacle 5, as shown. The control unit 8 is also connected to a touchscreen as a display and operating means 23. The control unit 8 is designed in particular to ascertain a flow and/or a pressure of the electrolyte.

With the apparatus 1, the following method for galvanically growing a plurality of nanowires 2 on the substrate 3 can be carried out:
a) placing the substrate 3 into the substrate holder 4,
b) inserting the substrate holder 4 into the receptacle 5 for the substrate holder 4,
c) galvanically growing the nanowires 2 on the substrate 3, a temperature of the substrate 3 lying between 15° C. and 100° C.

On the substrate 3 there lies a foil 28 (which cannot be seen in detail in FIG. 1) with passing-through pores 29 (which can be seen in FIG. 2). On the foil 28 there lies a sponge as an elastic element 19, by way of which an electrolyte can be released onto the foil 28. On the elastic element 19 there lies an electrode 12. By applying an electrical voltage between the surface 27 of the substrate 3 and the electrode 12, the nanowires 2 can be grown. The electrode 12 is held by way of a ram 20 and, using this, can be moved by means of a drive 21.

The electronics 6 of the substrate holder 4 influence the growing of the nanowires 2 according to step c). The electronics 6 of the substrate holder 4 comprise a digitizing unit 9, which is connected to the control unit 8 for digital communication. Furthermore, the electronics 6 of the substrate holder 4 comprise a sensory 10, which in the embodiment shown is formed by two sensors. Moreover, the electronics 6 of the substrate holder 4 comprise a memory 24. In this there may be stored, for example, growth parameters that are taken into account during the growing of the nanowires 2. In addition, the electronics 6 of the substrate holder 4 are designed to control an electrical voltage or an electrical current for the growing of the nanowires 2. The electronics 6 are also attached to a heater 14, with which the substrate 3 can be heated.

The apparatus 1 has a housing 34 inside which the chamber 18 is formed. An inner side 42 of the chamber 18 is formed from an electrolyte-resistant material. The receptacle 5 for the substrate holder 4 is formed in the chamber 18, so that the substrate holder 4 can be received by the chamber 18. The chamber 18 has an opening 17, by way of which the substrate holder 4 can be inserted into the chamber 18 and can be moved out of the chamber 18. The opening 17 may be closed by way of a flap 16. The flap 16 may be locked with a locking mechanism 22. The apparatus 1 is designed to grow the plurality of nanowires 2 from the electrolyte onto the substrate 3 when the substrate holder 4 with the substrate 3 has been received in the receptacle 5.

Also arranged in the housing 34 are three storage tanks 35 for a respective electrolyte. One of the storage tanks 35 is attached to an electrolyte line 37 by way of a connection 36 and a pump 38. By way of the electrolyte line 37, the electrolyte can be introduced into the substrate holder 4 and used for the growing of the nanowires 2. The pump 38 is designed to pump the electrolyte out of the storage tank 35 into the chamber 18. The pump 38 is held in a damped manner by means of a damper 40 on a support 39, which is held in a damped manner by way of a further damper 40 in the housing 34. The connection 36 has a sensor (not shown any more specifically), with which the storage tank 35 can be identified by way of the control unit 8 and at least one parameter assigned to the storage tank 35 can be ascertained. Also arranged in the housing 34 are a filter 41 for the electrolyte and an electrolyte processor 42. In the embodiment shown, the filter 41 and the electrolyte processor 42 are integrated in the electrolyte line 37. Details of the electrolyte processor 42 are not shown for the sake of overall clarity. Thus, the electrolyte processor 42 may for example be connected by way of a line to a tank by way of which substances that can be used for processing the electrolyte are fed to the electrolyte processor 42.

FIG. 2 shows part of the apparatus 1 from FIG. 1 in a schematic representation. The substrate 3 is shown, with the surface 27 onto which the nanowires 2 are to be grown. A foil 28, which has a plurality of passing-through pores 29, in which the nanowires 2 can be grown from an electrolyte, has been placed onto the surface 27 of the substrate 3. The surface 27 of the substrate 3 has a structuring layer 31 with clearances 32. The nanowires 2 can only be grown in the clearances 32. Thus, the growing of the nanowires 2 can take place locally selectively. Furthermore, an elastic element 19 permeable to the electrolyte has been placed onto the foil 27. The electrolyte can be brought into contact with the foil 28 by way of the elastic element 19. Also shown in FIG. 2 is a voltage source 30 (not shown in FIG. 1 for the sake of overall clarity), which is connected to an electrode 12 and the surface 27 of the substrate 3 for applying an electrical voltage for the growing of the nanowires 2. The electrode 12 may be pressed against the elastic element 19 with a ram 20.

FIG. 3 shows further elements of the apparatus 1 from FIGS. 1 and 2 that are not shown in FIGS. 1 and 2 for the sake of overall clarity. Thus, along with the voltage source 30, the electrode 12 and the substrate 3 with the surface 27, also shown is a reference electrode 11. The reference electrode 11 is connected to the surface 27 of the substrate 3 by way of a voltmeter 33. The voltage source 30 and the reference electrode 11 are attached to the surface 27 of the substrate 3 independently of one another.

FIG. 4 shows a configuration of an electrode 12 for the apparatus 1 from FIGS. 1 and 2. The electrode 12 has a multiplicity of independently controllable segments 13. The electrode 12 is shown in a plan view. The surface 27 to be grown on of the substrate 3 would lie parallel to the plane of the drawing.

FIG. 5 shows a configuration of a heater 14 for the apparatus 1 from FIGS. 1 and 2. The heater 14 has a multiplicity of independently controllable segments 15. The heater 14 is shown in a plan view. The surface 27 to be grown on of the substrate 3 would lie parallel to the plane of the drawing. A heater 14 as shown in FIG. 5 may be used instead of the simple heater 14 shown in FIG. 1.

### LIST OF REFERENCE SIGNS

1 Apparatus
2 Nanowires
3 Substrate
4 Substrate holder
5 Receptacle
6 Electronics
7 Interface
8 Control unit
9 Digitizing unit
10 Sensory
11 Reference electrode
12 Electrode
13 Segment
14 Heater
15 Segment
16 Flap
17 Opening
18 Chamber
19 Elastic element
20 Ram
21 Drive
22 Locking mechanism
23 Display and operating means
24 Memory
25 Guide rail
26 Arresting mechanism
27 Surface
28 Foil
29 Pore
30 Voltage source
31 Structuring layer
32 Clearance
33 Voltmeter
34 Housing
35 Storage tank
36 Connection
37 Electrolyte line
38 Pump
39 Support
40 Damper
41 Filter
42 Inner side
43 Electrolyte processor

1. Apparatus for galvanically growing a plurality of nanowires on a substrate, comprising a substrate holder and a receptacle for the substrate holder, the apparatus being designed to grow the plurality of nanowires on the substrate when the substrate holder with the substrate has been received in the receptacle, the substrate holder having electronics which are designed to influence the growing of the nanowires.

2. Apparatus according to claim 1, wherein the substrate holder has an interface, by way of which the electronics are connected to a control unit of the apparatus when the substrate holder has been received in the receptacle.

3. Apparatus according to claim 2, wherein the electronics of the substrate holder comprise a digitizing unit, which is connected to the control unit for digital communication.

4. Apparatus according to claim 1, wherein the electronics of the substrate holder comprise a sensory.

5. Apparatus according to claim 1, also comprising a reference electrode, which is connected to the substrate when the substrate holder with the substrate has been received in the receptacle.

6. Apparatus according to claim 1, wherein an electrode of the apparatus designed for the galvanic growing of the nanowires has a multiplicity of independently controllable segments and/or wherein the substrate holder has a heater with a multiplicity of independently controllable segments.

7. Apparatus according to claim 1, wherein the electronics of the substrate holder are designed to control an electrical voltage or an electrical current for the growing of the nanowires.

8. Method for galvanically growing a plurality of nanowires on a substrate, comprising
a) placing the substrate into a substrate holder,
b) inserting the substrate holder into a receptacle for the substrate holder,
c) galvanically growing the nanowires on the substrate,
the substrate holder having electronics which influence the growing of the nanowires.

9. Method according to claim 8, wherein, before step a), growth parameters that are taken into account in step c) are stored in the electronics of the substrate holder.

10. Method according to claim 8, wherein a temperature of the substrate lies between 15° C. and 100° C. in step c).

11. Apparatus according to claim 2, wherein the electronics of the substrate holder comprise a sensory.

12. Apparatus according to claim 2, also comprising a reference electrode, which is connected to the substrate when the substrate holder with the substrate has been received in the receptacle.

13. Apparatus according to claim 2, wherein an electrode of the apparatus designed for the galvanic growing of the nanowires has a multiplicity of independently controllable segments and/or wherein the substrate holder has a heater with a multiplicity of independently controllable segments.

14. Apparatus according claim 2, wherein the electronics of the substrate holder are designed to control an electrical voltage or an electrical current for the growing of the nanowires.

15. Apparatus according to claim 3, wherein the electronics of the substrate holder comprise a sensory.

16. Apparatus according to claim 3, also comprising a reference electrode, which is connected to the substrate when the substrate holder with the substrate has been received in the receptacle.

17. Apparatus according to claim 3, wherein an electrode of the apparatus designed for the galvanic growing of the nanowires has a multiplicity of independently controllable segments and/or wherein the substrate holder has a heater with a multiplicity of independently controllable segments.

18. Apparatus according claim 3, wherein the electronics of the substrate holder are designed to control an electrical voltage or an electrical current for the growing of the nanowires.

19. Method according to claim 9, wherein a temperature of the substrate lies between 15° C. and 100° C. in step c).
